(19) United States
(12) Patent Application Publication
(10) Pub. No.: US 2017/0218183 A1
(43) Pub. Date: Aug. 3, 2017

(54) RESIN COMPOSITION, RESIN MOLDED ARTICLE, AND METHOD OF PREPARING RESIN COMPOSITION

(71) Applicant: FUJI XEROX CO., LTD., Tokyo (JP)

(72) Inventor: Kenji YAO, Kanagawa (JP)

(73) Assignee: FUJI XEROX CO., LTD., Tokyo (JP)

(21) Appl. No.: 15/205,540

(22) Filed: Jul. 8, 2016

(30) Foreign Application Priority Data
Feb. 2, 2016 (JP) 2016-018245

(51) Int. Cl. C08L 1/12

(52) U.S. Cl. CPC C08L 1/12; C08L 2205/02; C08L 2205/16; C08L 2201/10; C08L 2205/06; B29C 45/0001

(57) ABSTRACT

A resin composition includes cellulose nanofibers (A) and a cellulose ester resin (B) having a polymerization degree of 100 to 500 and a substitution degree of 2.1 to 2.6.

### CROSS-REFERENCE TO RELATED APPLICATIONS

This application is based on and claims priority under 35 USC 119 from Japanese Patent Application No. 2016-018245 filed Feb. 2, 2016.

### BACKGROUND

1. Technical Field

The present invention relates to a resin composition, a resin molded article, and a method of preparing a resin composition.

2. Related Art

In the related art, various resin compositions are provided and are used to prepare a resin molded article.

On the other hand, recently, the use of plant-derived resins has been considered, and one of the plant-derived resins is a cellulose derivative.

### SUMMARY

According to an aspect of the invention, there is provided a resin composition including:

cellulose nanofibers (A), and

a cellulose ester resin (B) having a polymerization degree of 100 to 500 and a substitution degree of 2.1 to 2.6.

### DETAILED DESCRIPTION

Hereinafter, exemplary embodiments of the invention will be described below. The description of these exemplary embodiments and examples are merely exemplary of the invention and do not limit the scope of the invention.

In the description of this specification regarding the amount of respective components in a composition, in a case where plural types of materials correspond to the respective components in the composition, unless described otherwise, the amount of the respective components in the composition refers to the total amount of the plural types of materials present in the composition.

### Resin Composition

A resin composition according to an exemplary embodiment of the invention includes: cellulose nanofibers (A); and a cellulose ester resin (B) having a polymerization degree of 100 to 500 and a substitution degree of 2.1 to 2.6.

Using the resin composition according to the exemplary embodiment having the above-described configuration, a resin molded article having high transparency and high bending elastic modulus may be obtained.

The reason is not clear but is presumed to be as follows.

In the related art, as a raw material for forming a resin molded article, a resin composition which includes a cellulose resin and a resin composition which further includes cellulose nanofibers in addition to the above-described resin composition are known. During molding using the resin composition including a cellulose resin as a main component, it is required to form a resin molded article having high transparency and high bending elastic modulus.

However, since a hydroxyl group is present in the molecules thereof, a cellulose resin has a low fluidity even at a decomposition temperature due to the effect of a intermolecular hydrogen bond. Therefore, a cellulose resin has low compatibility with a molding method such as injection molding in which fluidity is required. In the related art, as a technique of improving the fluidity of a cellulose resin, a technique of adding a plasticizer has been disclosed. However, when a plasticizer is added, the fluidity is improved, but the bending elastic modulus of a resin molded article obtained using this technique is likely to decrease.

On the other hand, in a case where the polymerization degree of a cellulose resin is high at about 800 (weight average molecular weight: about 200,000), it is necessary to increase the molding temperature during the molding of a cellulose resin. However, when the molding temperature increases, a resin molded article obtained using this technique is yellowed in many cases, and the transparency is likely to decrease.

On the other hand, the resin composition according to the exemplary embodiment has a configuration in which cellulose nanofibers (A) are added to a cellulose ester resin (B) having a polymerization degree of 100 to 500 and a substitution degree of 2.1 to 2.6.

The polymerization degree of the cellulose ester resin being 100 to 500 means that the polymerization degree is relatively low. That is, in the cellulose ester resin, the number of terminal hydroxyl groups increases due to a relatively low polymerization degree. Therefore, when the cellulose ester resin is mixed with the cellulose nanofibers, the number of binding sites between the cellulose ester resin and the cellulose nanofibers (that is, sites where hydrogen bonds are formed) increases. As a result, the bondability (bonding strength) of interfaces between the cellulose ester resin and the cellulose nanofibers is improved. Further, during the mixing of the cellulose ester resin and the cellulose nanofibers, the number of the above-described binding sites increases, and materials containing cellulose as a component (the cellulose ester resin and the cellulose nanofibers) are mixed with each other. Therefore, it is presumed that the bonding strength of the interfaces is likely to be strong due to affinity between the celluloses, and that the dispersibility of the cellulose nanofibers in the cellulose ester resin is improved.

In addition, the cellulose nanofibers are nano-sized. Therefore, even when a relatively large amount of the cellulose nanofibers are added to the cellulose ester resin, the transparency of the resin composition is secured.

In the exemplary embodiment, it is presumed that the bonding strength of the interface between the cellulose ester resin and the cellulose nanofibers, and the dispersibility of the cellulose nanofibers contribute to improvement in the bending elastic modulus and the transparency of a resin molded article. Further, it is presumed that the bonding strength and the dispersibility also contribute to a reduction in the molding temperature during the molding of the resin composition.

In addition, the substitution degree of the cellulose ester resin is 2.1 to 2.6. As a result, it is presumed that an intermolecular hydrogen bond of the cellulose ester resin is released, and the filling (packing) between the molecules of the cellulose ester resin may be minimized. Thus, even with respect to a cellulose ester resin which thermal fluidity is typically not likely to be imparted, thermal fluidity is secured, and the resultant cellulose ester resin is likely to be molded (for example, injection molding) at a low temperature.

In the resin composition according to the exemplary embodiment, the bonding strength of the interfaces between the cellulose ester resin and the cellulose nanofibers, and the dispersibility of the cellulose nanofibers are improved, and the transparency and the fluidity are secured.

Accordingly, by molding the resin composition according to the exemplary embodiment, a resin molded article having high transparency and high bending elastic modulus may be obtained.

In the resin composition according to the exemplary embodiment, even in a case where the cellulose nanofibers are not surface-treated, a resin molded article having high transparency and high bending elastic modulus may be obtained.

The reason for this is presumed to be as follows. By mixing the cellulose ester resin having a relatively low polymerization degree and the cellulose nanofibers, which are materials containing cellulose as a component, with each other, the bonding strength of interfaces between the materials is likely to be strong, and the dispersibility of the cellulose nanofibers in the cellulose ester resin is improved.

Hereinafter, the details of each component of the resin composition according to the exemplary embodiment will be described.

### Cellulose Nanofibers (A)

The resin composition according to the exemplary embodiment includes cellulose nanofibers.

The cellulose nanofibers refer to cellulose fibers having an average fiber diameter of less than 1,000 nm.

### Average Fiber Diameter

The average fiber diameter of the cellulose nanofibers is not particularly limited as long as it is less than 1,000 nm but, from the viewpoint of obtaining a resin molded article having high transparency and high bending elastic modulus, is preferably 10 nm to 100 nm, more preferably 20 nm to 80 nm, and still more preferably 30 nm to 60 nm. By adjusting the average fiber diameter to be 10 nm or more, the effect of improving the bending elastic modulus of the resin molded article is likely to be exhibited. In addition, by adjusting the average fiber diameter to be 100 nm or less, the fluidity of the resin composition is secured, and the dispersibility of the cellulose nanofibers is likely to be improved. As a result, a resin molded article having high transparency is likely to be obtained.

The average fiber diameter of the cellulose nanofibers is calculated using the following method.

The cellulose nanofibers are dispersed in methylene chloride using a ball mill, and the methylene chloride is evaporated. Next, an image is obtained at a magnification of 1,000 times using an electron microscope, 100 cellulose nanofibers are selected from the obtained image, the widths (diameters) thereof are measured, and the number average fiber diameter thereof is calculated.

### Aspect Ratio

From the viewpoint of obtaining a resin molded article having high transparency and high bending elastic modulus, the aspect ratio of the cellulose nanofibers is preferably 100 to 500, more preferably 150 to 400, and still more preferably 200 to 350. By adjusting the aspect ratio to be 100 or more, the effect of improving the bending elastic modulus of the resin molded article is likely to be exhibited. In addition, by adjusting the aspect ratio to be 500 or less, the fluidity of the resin composition is secured, and the dispersibility of the cellulose nanofibers is likely to be improved. As a result, a resin molded article having high transparency is likely to be obtained.

The aspect ratio of the cellulose nanofibers is calculated using the following method.

Using the same method as the method of measuring the average fiber diameter, the lengths of 100 cellulose nanofibers, which are selected from an image obtained using an electron microscope, are measured, and the number average fiber length is calculated.

A ratio (average fiber length/average fiber diameter) of the calculated average fiber length to the average fiber diameter calculated using the above-described method is calculated as the aspect ratio of the cellulose nanofibers.

### Whether or not to be Surface-Treated

The cellulose nanofibers used in the exemplary embodiment may be or may not be surface-treated. However, it is preferable that the cellulose nanofibers are not surface-treated due to the following reason.

In the exemplary embodiment, as described above, the cellulose ester resin having a relatively low polymerization degree and the cellulose nanofibers are mixed with each other. Therefore, the bonding strength of an interface between the two materials (interfaces between the cellulose ester resin and the cellulose nanofibers) is likely to be strong. In addition, by allowing the bonding strength of the interfaces between the two materials to be strong, gaps are not likely to be generated in the interfaces, and the adsorption of moisture on the interfaces is prevented. As a result, foaming is prevented during the molding (for example, injection molding) of the resin composition, and the weight of a resin molded article obtained from the resin composition is not likely to vary, and the strength of the resin molded article is likely to be improved.

In addition, since both the cellulose ester resin and the cellulose nanofibers contain cellulose as a component, the dispersibility of the cellulose nanofibers in the cellulose ester resin is also improved.

Accordingly, by using the cellulose nanofibers which are not surface-treated, the moldability of the resin composition and the dispersibility of the cellulose nanofibers are further improved, and a resin molded article having high transparency and high bending elastic modulus is likely to be obtained.

In a case where the cellulose nanofibers are surface-treated, examples of a surface treatment method include a method of introducing a reactive group using an acid treatment; a method of introducing a reactive group using a silane coupling agent; a method of using an amphipathic polymer; a surface treatment method using tetramethylpiperidine (TEMPO method); a surface treatment method using an epoxy compound; a surface treatment method using a glycidyl compound; and a surface treatment method using a woody component such as lignin or hemicellulose (lignin/hemicellulose method).

Among these, a TEMPO method or a lignin/hemicellulose method is preferable from the viewpoint of improving the dispersibility of the cellulose nanofibers.

### Cellulose Ester Resin (B)

The resin composition according to the exemplary embodiment includes a cellulose ester resin.

The cellulose ester resin used in the exemplary embodiment has a polymerization degree of 100 to 500 and a substitution degree of 2.1 to 2.6.

Specific examples of the cellulose ester resin include a cellulose ester resin represented by formula (1).

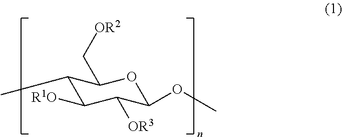

In the formula (1), R¹, R², and R³ each independently represents a hydrogen atom, and an acyl group having 1 to 3 carbon atoms. n represents an integer of 1 or more.

In the formula (1), examples of the acyl groups represented by R¹, R², and R³ include an acetyl group, a propionyl group, and a butyryl group. As the acyl group, an acetyl group is preferable from the viewpoint of obtaining a resin molded article having high transparency and high bending elastic modulus. In addition, from the viewpoint of improving the moldability of the resin composition, an acetyl group is preferable as the acyl group.

In the formula (1), the range of n is not particularly limited but is preferably 250 to 750 and more preferably 350 to 600.

By adjusting n to be 250 or more, the strength of the resin molded article is likely to be improved. By adjusting n to be 750 or less, a decrease in the flexibility of the resin molded article is likely to be prevented.

Here, in the formula (1), R¹, R², and R³ each independently representing an acyl group implies that at least a part of hydroxyl groups in the cellulose ester resin represented by the formula (1) are acylated.

That is, a part or all of n number of R¹'s present in the molecules of the cellulose ester resin may be the same as each other, and all of n number of R¹'s present in the molecules of the cellulose ester resin may be different from each other. Likewise, a part or all of n number of R²'s and a part or all of n number of R³'s may be the same as or different from each other, respectively, and all of n number of R²'s and all of n number of R³'s may be different from each other.

### (Polymerization Degree)

From the viewpoint of obtaining a resin molded article having high transparency and high bending elastic modulus, the polymerization degree of the cellulose ester resin used in the exemplary embodiment is 100 to 500, preferably 200 to 400, and more preferably 200 to 350.

As described above, the polymerization degree of the cellulose ester resin being 100 to 500 represents the polymerization degree being relatively low.

That is, by adjusting the polymerization degree to be 100 or more, intermolecular entanglement of the cellulose ester resin is likely to occur. As a result, the bending elastic modulus of the resin molded article is likely to be improved. On the other hand, by adjusting the polymerization degree to be 500 or less, the number of binding sites in the interfaces between the cellulose ester resin and the cellulose nanofibers increases. The bonding strength of the interface between the cellulose ester resin and the cellulose nanofibers, and the dispersibility of the cellulose nanofibers are likely to be improved. As a result, the transparency of the resin molded article is likely to decrease, and molding stability is likely to be secured.

Here, the polymerization degree of the cellulose ester resin is obtained based on the weight average molecular weight through the following procedure.

First, the weight average molecular weight of the cellulose ester resin is measured in terms of polystyrene using a solution (dimethylacetamide/lithium chloride=90/10 by volume) using a GPC system (HLC-8320GPC, manufactured by Tosoh Corporation, column: TSKgel α-M).

Next, by dividing the weight average molecular weight of the cellulose ester resin by the repeat unit molecular weight of the cellulose ester resin, the polymerization degree of the cellulose ester resin is obtained. The repeat unit molecular weight is, for example, 263 in a case where the substitution degree with an acetyl group is 2.4 and 287 in a case where the substitution degree with an acetyl group is 2.9.

### Substitution Degree

From the viewpoint of obtaining a resin molded article having high transparency and high bending elastic modulus, the substitution degree of the cellulose ester resin is 2.1 to 2.6, preferably 2.2 to 2.55, and more preferably 2.3 to 2.5.

By adjusting the substitution degree to be in the above-described range, it is presumed that an intermolecular hydrogen bond of the cellulose ester resin is released, and the filling (packing) between the molecules of the cellulose ester resin may be minimized. Thus, typically, even with respect to a cellulose ester resin which thermal fluidity is typically not likely to be imparted to, thermal fluidity is secured, and the cellulose ester resin is likely to be molded (for example, injection molding) at a low temperature.

The substitution degree is an index indicating the degree to which a hydroxyl group included in cellulose is substituted with a substituent. As described above, when the substituent is an acyl group, the substitution degree is an index indicating the acylation degree of the cellulose ester resin. Specifically, the substitution degree refers to the intermolecular average number of hydroxyl groups substituted with an acyl group among three hydroxyl groups in one D-glucopyranose of the cellulose ester resin.

The substitution degree is measured based on an integral ratio of cellulose-derived hydrogen to an acyl group-derived peak in H¹-NMR (JNM-ECA, manufactured by JEOL RESONANCE Inc.).

Here, from the viewpoint of obtaining a resin molded article having high transparency and high bending elastic modulus, in particular, it is preferable that the cellulose ester resin includes acetyl groups as the acyl groups represented by R¹, R², and R³ and have a polymerization degree of 100 to 500 and a substitution degree of 2.1 to 2.6.

Hereinafter, specific examples of the cellulose ester resin are shown, but the invention is not limited thereto. Specific examples of the cellulose ester resin include the following cellulose ester resins whose substitution degree are adjusted to be 2.1 to 2.6 by modifying the resins.

Diacetyl cellulose (trade name: L-50, manufactured by Daicel Corporation, the substituents R¹, R², and R³ each independently represents a hydrogen atom or an acetyl group)

Diacetyl cellulose (trade name: L-20, manufactured by Daicel Corporation, the substituents R¹, R², and R³ represent a hydrogen atom or an acetyl group)

Cellulose triacetate (trade name: LT-55, manufactured by Daicel Corporation, the substituents R¹, R², and R³ represent a hydrogen atom or an acetyl group)

Cellulose acetate propionate (trade name: CAP482-20, manufactured by Eastman Chemical Co., the substituents R¹, R², and R³ represent a hydrogen atom, an acetyl group, or a propionyl group)

Cellulose acetate butylate (trade name: CAB381-0.1, manufactured by Eastman Chemical Co., the substituents R¹, R², and R³ represent a hydrogen atom, an acetyl group, or a butyryl group)

Cellulose acetate (trade name: CA398-3, manufactured by Eastman Chemical Co., the substituents R¹, R², and R³ represent a hydrogen atom or an acetyl group)

### Preparing Method

A method of preparing the cellulose ester resin used in the exemplary embodiment is not particularly limited, and a well-known method is adopted.

Hereinafter, the method of preparing the cellulose ester resin (B) having a polymerization degree of 100 to 500 and a substitution degree of 2.1 to 2.6 (hereinafter, also referred to as “specific cellulose ester resin”) will be described using an example.

### Adjustment of Polymerization Degree of Cellulose Resin

First, non-acylated cellulose, that is, cellulose in which a hydroxyl group is not substituted with an acyl group is prepared, and the polymerization degree thereof is adjusted.

The non-acylated cellulose may be synthesized or may be commercially available. Cellulose is a plant-derived resin, and the weight average molecular weight thereof is generally higher than that of the specific cellulose ester resin used in the exemplary embodiment. Therefore, the adjustment of the polymerization degree of cellulose is typically a step of reducing the polymerization degree.

For example, the polymerization degree of a commercially available cellulose is typically 1,000 to 10,000.

Examples of a commercially available non-acylated cellulose include KC FLOCK W50, W100, W200, W300G, W400G, W-100F, W60MG, W-50GK, W-100GK, NDPT, NDPS, LNDP, and NSPP-HR (all of which are manufactured by Nippon Paper Industries Co., Ltd.).

A method of adjusting the polymerization degree of the non-acylated cellulose is not particularly limited, and examples thereof include a method of stirring the non-acylated cellulose in liquid to reduce the polymerization degree thereof.

By adjusting the stirring rate, stirring time, and the like, the molecular weight of the cellulose may be adjusted to a desired value. Although not particularly limited, the stirring rate is particularly 50 rpm to 3,000 rpm, and more preferably 100 rpm to 1,000 rpm. In addition, the stirring time is preferably 2 hours to 48 hours, and more preferably 5 hours to 24 hours.

Examples of the liquid used during the stirring include an aqueous hydrochloric acid solution, an aqueous formic acid solution, an aqueous acetic acid solution, an aqueous nitric acid solution, and an aqueous sulfuric acid solution.

### Preparation of Cellulose Ester Resin

Cellulose whose polymerization degree is adjusted using the above-described or the like is acylated with an acyl group using a well-known method. As a result, the specific cellulose ester resin is obtained.

For example, in a case where a part of hydroxyl groups included in the cellulose are substituted with an acetyl group, a method of esterifying the cellulose using a mixture of acetic acid, acetic anhydride, and sulfuric acid is used. In addition, in a case where a part of hydroxyl groups included in the cellulose are substituted with a propionyl group, a method of esterifying the cellulose using propionic anhydride instead of the acetic anhydride in the mixture is used. In a case where a part of hydroxyl groups included in the cellulose are substituted with a butanoyl group, a method of esterifying the cellulose using butyric anhydride instead of the acetic anhydride in the mixture is used. In a case where a part of hydroxyl groups included in the cellulose are substituted with a hexanoyl group, a method of esterifying the cellulose using hexanoic anhydride instead of the acetic anhydride in the mixture is used.

After the acylation, a deacylation step may be further provided in order to adjust the substitution degree. In addition, after the acylation step or the deacylation step, a purification step may be further provided.

### (Ratio in Resin Composition)

### Weight Ratio of Cellulose Ester Resin

In the resin composition according to the exemplary embodiment, from the viewpoint of obtaining a resin molded article having high transparency and high bending elastic modulus, a weight ratio of the cellulose ester resin to the total amount of the resin composition is preferably 75% to 99.9%, more preferably 80% to 99%, and still more preferably 85% to 95%.

By adjusting the weight ratio to be 75% or higher, secondary aggregation of the cellulose nanofibers is likely to be prevented. Therefore, the transparency of the resin molded article is likely to be improved.

In addition, by adjusting the weight ratio to be 99.9% or lower, the bending elastic modulus of the resin molded article is likely to be improved.

### Weight Ratio of Cellulose Nanofibers (A) to Specific Cellulose Ester Resin (B)

From the viewpoint of obtaining a resin molded article having high transparency and high bending elastic modulus, a weight ratio (cellulose nanofibers (A)/specific cellulose ester resin (B)) of the cellulose nanofibers (A) to the specific cellulose ester resin (B) is preferably 0.0008 to 0.40, more preferably 0.001 to 0.35, and still more preferably 0.005 to 0.3.

By adjusting the weight ratio to be 0.0008 or higher, the fiber reinforcing effect obtained by the addition of the cellulose nanofibers is likely to be exhibited. Therefore, the bending elastic modulus of the resin molded article is likely to be improved. In addition, by adjusting the weight ratio to be 0.40 or lower, secondary aggregation of the cellulose nanofibers is not likely to occur. Therefore, the transparency of the resin molded article is likely to be improved.

### Adipic Acid Ester-Containing Compound

It is preferable that the resin composition according to the exemplary embodiment further contains an adipic acid ester-containing compound.

Here, the adipic acid ester-containing compound (compound containing an adipic acid ester) refers to an adipic acid ester alone, or a mixture of an adipic acid ester and a component other than an adipic acid ester (a compound different from an adipic acid ester).

However, from the viewpoint of improving the fluidity of the resin composition, the adipic acid ester-containing compound contains preferably 50% by weight or higher of the adipic acid ester with respect to all the components.

In addition, from the viewpoint of obtaining a resin molded article having high transparency and high bending elastic modulus at a low molding temperature, the ratio of the adipic acid ester-containing compound to the total amount of the resin composition is preferably 15% by weight or lower, more preferably 10% by weight or lower, and still more preferably 5% by weight or lower.

By adjusting the ratio of the adipic acid ester-containing compound to the total amount of the resin composition to be 15% by weight or lower, a decrease in the bending elastic modulus of the resin molded article obtained at a low molding temperature is likely to be prevented. In addition, the transparency of the resin molded article is also improved. Further, the bleeding of the adipic acid ester-containing compound is likely to be prevented.

As the adipic acid ester, for example, adipic acid diester, and adipic acid polyester are exemplified. Specifically, adipic acid diester represented by the formula (2-1) and adipic acid polyester represented by the formula (2-2) are exemplified.

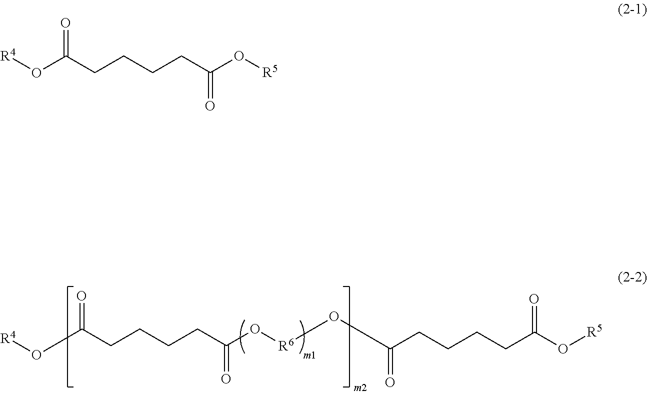

In the formulae (2-1) and (2-2), R⁴ and R⁵ each independently represents an alkyl group, or a polyoxyalkyl group [—(CₓH_{2X}—O)_{y}—R^{A1}] (provided that R^{A1} represents an alkyl group, x represents an integer in the range of 1 to 10, and y represents an integer in the range of 1 to 10.

R⁶ represents an alkylene group.

m1 represents an integer in the range of 1 to 20.

m2 represents an integer in the range of 1 to 10.

In the formulae (2-1) and (2-2), the alkyl groups represented by R⁴ and R⁵ are preferably alkyl groups having 1 to 6 carbon atoms, and more preferably alkyl groups having 1 to 4 carbon atoms. The alkyl groups represented by R⁴ and R⁵ may have any one of a linear shape, a branched shape, or a cyclic shape, but preferably a linear shape and a branched shape.

In the formulae (2-1) and (2-2), in the polyoxyalkyl group represented by R⁴ and R⁵ [—(CₓH_{2X}—O)_{y}—R^{A1}], the alkyl group represented by R^{A1} is preferably an alkyl group having 1 to 6 carbon atoms, and more preferably an alkyl group having 1 to 4 carbon atoms. The alkyl group represented by R^{A1} may have any one of a linear shape, a branched shape, or a cyclic shape, but preferably a linear shape and a branched shape.

In the formula (2-2), the alkylene group represented by R⁶ is preferably an alkylene group having 1 to 6 carbon atoms, and more preferably an alkylene group having 1 to 4 carbon atoms. The alkylene group represented by R⁶ may have any one of a linear shape, a branched shape, or a cyclic shape, but preferably a linear shape and a branched shape.

In the formulae (2-1) and (2-2), the group represented by each of symbols R⁴ to R⁶ may be substituted with a substituent. As the substituent, an alkyl group, an aryl group, and a hydroxyl group are exemplified.

The molecular weight of the adipic acid ester (or weight average molecular weight) is preferably in the range of 200 to 5,000, and more preferably in the range of 300 to 2,000. The weight average molecular weight is a value measured according to the method of measuring the weight average molecular weight of the cellulose derivative described above.

Specific examples of the adipic acid ester-containing compound are described below, but the invention is not limited thereto.

| | Name of Material | Name of Product | Manufacturer |
|---|---|---|---|
| ADP1 | Adipic acid | Daifatty 101 | Daihachi Chemical |
| | diester | | Industry Co., Ltd. |
| ADP2 | Adipic acid | Adeka Cizer RS-107 | ADEKA Corporation |
| | diester | | |
| ADP3 | Adipic acid | Polycizer W-230-H | DIC Corporation |
| | polyester | | |

Other Components

The resin composition according to the exemplary embodiment may contain other components in addition to the components described above, if necessary.

As the other components, for example, a flame retardant, a compatibilizer, an antioxidant, a release agent, a light resistant agent, a weather resistant agent, a colorant, pigments, a modifier, a drip preventing agent, an antistatic agent, a hydrolysis inhibitor, a filler, and a reinforcing agent (glass fiber, carbon fiber, talc, clay, mica, glass flake, milled glass, glass bead, crystalline silica, alumina, silicon nitride, aluminum nitride, boron nitride, and the like) are exemplified. The content of the respective components is in the range of 0% by weight to 5% by weight with respect to the total amount of the resin composition. Here, the expression “0% by weight” means not including other components.

The resin composition according to the exemplary embodiment may contain other resins in addition to the resin described above.

As the other resins, for example, the thermoplastic resins which are well-known in the art are included. Specifically, polycarbonate resin; polypropylene resin; polyester resin; a polyolefin resin; polyester carbonate resin; a polyphenylene ether resin; polyphenylene sulfide resin; a polysulfone resin; polyether sulfone resin; a polyarylene resin; a polyetherimide resin; a polyacetal resin; a polyvinyl acetal resin; a polyketone resin; a polyetherketone resin; a polyetheretherketone resin; a polyarylketone resin; a polyether nitrile resin; a liquid crystal resin; a polybenzimidazole resin; polyparabanic acid resin; a vinyl polymer or a vinyl copolymer resin obtained by polymerizing or copolymerizing one or more vinyl monomers selected from the group consisting of an aromatic alkenyl compound, a methacrylic acid ester, acrylic acid ester, and a vinyl cyanide compound; a diene-aromatic alkenyl compound copolymer resin; a vinyl cyanide-diene-aromatic alkenyl compound copolymer resin; an aromatic alkenyl compound-diene-vinyl cyanide-N-phenylmaleimide copolymer resin; a vinyl cyanide-(ethylene-diene-propylene (EPDM))-aromatic alkenyl compound copolymer resin; a vinyl chloride resin; and a chlorinated vinyl chloride resin are exemplified. These resins may be used singly, or two or more types thereof may be used in combination.

### Method of Preparing Resin Composition

In a method of preparing a resin composition according to an exemplary embodiment of the invention, a resin composition is prepared through a step of kneading cellulose nanofibers (A) and a cellulose ester resin (B) having a polymerization degree of 100 to 500 and a substitution degree of 2.1 to 2.6 (that is, the specific cellulose ester resin) with each other by means of a kneading machine having a cylinder temperature of 180° C. to 220° C.

In the method of preparing a resin composition according to the exemplary embodiment, even when the cylinder temperature during the kneading is relatively low at 180° C. to 220° C., a resin composition may be obtained, which is capable of being molded (for example, injection molding) at a temperature where fluidity is secured and where the cellulose ester resin is not likely to be thermally decomposed.

By molding the resin composition according to the exemplary embodiment, a resin molded article having high transparency and high bending elastic modulus may be obtained.

In the method of preparing a resin composition according to the exemplary embodiment, first, the cellulose nanofibers and the specific cellulose ester resin are put into a kneading machine.

The cellulose nanofibers and the specific cellulose ester resin, which are raw materials, may be directly put into a kneading machine. Alternatively, a mixture (raw material) of the cellulose nanofibers and the specific cellulose ester resin is prepared in advance, and the mixture is put into a kneading machine. In addition, in addition to the cellulose nanofibers and the specific cellulose ester resin, optionally, a plasticizer, the above-described other components, a solvent, and the like may be directly put into a kneading machine, or may be added to the mixture first and then put into a kneading machine.

In addition, the specific cellulose ester resin is not particularly limited and may have the form of an aqueous dispersion, a sheet, powder, a pellet, a fiber, or the like.

Next, the raw materials put into the kneading machine are kneaded with each other.

From the viewpoint of reducing the molding temperature while securing the fluidity of the resin composition, the cylinder temperature during the kneading is 180° C. to 220° C., preferably 185° C. to 210° C., and more preferably 190° C. to 200° C.

Here, a well-known unit is used as a kneading unit (that is, a kneading machine), and specific examples thereof include a twin-screw extruder, a HENSCHEL mixer, a BANBURY mixer, a single-screw extruder, a multi-screw extruder, and a co-kneader. Among these, a twin-screw extruder is preferably used.

### Resin Molded Article

A resin molded article according to an exemplary embodiment of the invention includes the resin composition according to the exemplary embodiment.

That is, the resin molded article according to the exemplary embodiment has the same composition as the resin composition according to the exemplary embodiment.

Specifically, the resin molded article according to the exemplary embodiment may be obtained by molding the resin composition according to the exemplary embodiment. Examples of a molding method include injection molding, extrusion molding, blow molding, hot press molding, calendering, coating molding, cast molding, dipping molding, vacuum molding, and transfer molding.

As the molding method of the resin molded article according to the exemplary embodiment, injection molding is preferable from the viewpoint of obtaining high degree of freedom for the shape. Regarding injection molding, the resin composition is heated to melt, is cast, and is solidified to obtain the resin molded article. The resin composition may be molded by injection compression molding.

The cylinder temperature during injection molding may be determined according to the kneading temperature of the resin composition. For example, the cylinder temperature during injection molding is 180° C. to 220° C., preferably 185° C. to 210° C., and more preferably 190° C. to 200° C. The injection molding may be performed using a commercially available machine such as NEX500 (manufactured by Nissei Plastic Industrial Co., Ltd.), NEX150 (manufactured by Nissei Plastic Industrial Co., Ltd.), NEX70000 (manufactured by Nissei Plastic Industrial Co., Ltd.), or SE50D (manufactured by Toshiba Machine Co., Ltd.).

The resin molded article according to the exemplary embodiment is preferably used in applications such as electronic and electric apparatuses, business machines, home electronics, automobile interior materials, engine covers, vehicle bodies, and containers. Specific examples of the applications include: cases of electronic and electric apparatuses and home electronics; various components of electronic and electric apparatuses and home electronics, automobile interior components; storage cases of CD-ROM, DVD, and the like; tableware; beverage bottles; food trays; wrapping materials; films; and sheets.

### EXAMPLES

Hereinafter, the invention will be described in more detail using Examples but is not limited to these examples. Unless specified otherwise, “part(s)” represents “part(s) by weight”.

### Preparation of Cellulose Nanofibers (F1)

Softwood kraft pulp (NDP-T, manufactured by Nippon Paper Industries Co., Ltd.) is pulverized using a high-speed homogenizer until the average fiber diameter thereof reaches 1 μm or less. Next, in an environment filled with liquid nitrogen, using a grinder (KM1-10, manufactured by Kurita Machinery MFG. Co., Ltd.), the pulverized fibers are put into the center between two disks rotating at 1,200 rpm, and an operation of causing the fibers to move from the center of the disks to the outside thereof is repeated 10 times. Thus, cellulose nanofibers (F1) are obtained.

### Preparation of Cellulose Nanofibers (F2) to (F5)

Cellulose nanofibers (F2) are obtained using the same method as the preparation method for the cellulose nanofibers (F1), except that the operation of causing the fibers to move from the center of the disks to the outside thereof is repeated not 10 times but 20 times.

In addition, cellulose nanofibers (F3) are obtained using the same method as the preparation method of the cellulose nanofibers (F1), except that the operation of causing the fibers to move from the center of the disks to the outside thereof is repeated not 10 times but 30 times.

In addition, cellulose nanofibers (F4) are obtained using the same method as the preparation method of the cellulose nanofibers (F1), except that the operation of causing the fibers to move from the center of the disks to the outside thereof is repeated not 10 times but 40 times.

In addition, cellulose nanofibers (F5) are obtained using the same method as the preparation method of the cellulose nanofibers (F1), except that the operation of causing the fibers to move from the center of the disks to the outside thereof is repeated not 10 times but 8 times.

### Cellulose Nanofibers (F6) and (F7)

As cellulose nanofibers (F6), Bis-Fis (manufactured by Sugino Machine Ltd.) is prepared.

As cellulose nanofibers (F7), CELISH (manufactured by Daicel Corporation) is prepared.

### Cellulose Nanofibers (F8)

Cellulose nanofibers (F8) is obtained using the same method as the preparation method of the cellulose nanofibers (F1), except that the cellulose nanofibers (F1) are mixed with hemicellulose so as to be surface-treated.

Regarding each of the obtained cellulose nanofibers (F1) to (F8), the average fiber diameter and the average aspect ratio are measured using an existing method. The results are shown in Table 1.

TABLE 1

| Type of Cellulose | Average Fiber Diameter | Average Aspect |
|---|---|---|
| Fiber | (nm) | Ratio |
| F1 | 120 | 490 |
| F2 | 95 | 350 |
| F3 | 12 | 120 |
| F4 | 8 | 90 |
| F5 | 140 | 650 |
| F6 | 40 | 450 |
| F7 | 80 | 550 |
| F8 | 120 | 500 |
| (Surface-Treated) | | |

### Synthesis of Cellulose Ester Resin

### Synthesis of Cellulose Acetate (CA1)

20 kg of cellulose (KC FLOCK W50 manufactured by Nippon Paper Industries Co., Ltd.) is put into 20 L of a 0.1 M aqueous hydrochloric acid solution, is stirred with heating at 40° C. to perform acid-hydrolysis for 5 minutes. Thus, cellulose is obtained.

Next, over 15 kg of the obtained cellulose, 75 kg of acetic acid is sprayed to perform pre-treatment and activation. Next, a mixture of 38 kg of glacial acetic acid, 24 kg of acetic anhydride, and 350 g of sulfuric acid are added thereto, and the components are stirred and mixed with each other at a temperature of 40° C. or lower to perform esterification. It may be considered that, when no fiber fragments are observed, the esterification ends. Thus, triacetyl cellulose is obtained.

Next, the triacetyl cellulose is added dropwise to 200 L of distilled water. The mixture is stirred at room temperature for 1 hour, is filtered, and the resultant residue is dried at 60° C. for 72 hours.

After the drying, 20 kg of acetic acid, 10 kg of distilled water, and 800 g of hydrochloric acid are added and are caused to react with each other at 40° C. for 5 hours. Next, 5 kg of the reaction product is taken out, and 300 g of calcium acetate is added thereto. The mixture is stirred in 100 L of distilled water at room temperature for 2 hours, is filtered, and the resultant residue is dried at 60° C. for 72 hours. Thus, cellulose acetate (CA1) is obtained.

### Synthesis of Cellulose Acetate (CA2)

Cellulose acetate (CA2) is obtained using the same synthesis method of the cellulose acetate (CA1), except that the acid hydrolysis is performed not for 5 minutes but for 20 minutes.

### Synthesis of Cellulose Acetate (CA2-2)

Cellulose acetate (CA2-2) is obtained using the same synthesis method of the cellulose acetate (CA2), except that not 5 kg of the reaction product obtained after the reaction at 40° C. for 5 hours but 2 kg of the reaction product obtained after the reaction at 40° C. for 30 minutes is taken out.

### Synthesis of Cellulose Acetate (CA2-3)

Cellulose acetate (CA2-3) is obtained using the same synthesis method of the cellulose acetate (CA2), except that not 5 kg of the reaction product obtained after the reaction at 40° C. for 5 hours but 2 kg of the reaction product obtained after the reaction at 40° C. for 10 hours is taken out.

### Synthesis of Cellulose Acetate (CA3)

Cellulose acetate (CA3) is obtained using the same synthesis method of the cellulose acetate (CA1), except that the acid hydrolysis is performed not for 5 minutes but for 40 minutes.

### Synthesis of Cellulose Acetate (CA4)

Cellulose acetate (CA4) is obtained using the same synthesis method of the cellulose acetate (CA1), except that the acid hydrolysis is performed not for 5 minutes but for 60 minutes.

### Synthesis of Cellulose Acetates (CA5) to (CA9)

L20 (manufactured by Daicel Corporation) is prepared as cellulose acetate (CA5).

L50 (manufactured by Daicel Corporation) is prepared as cellulose acetate (CA6).

CE398-3 (manufactured by Eastman Chemical Co.) is prepared as cellulose acetate (CA7).

LT-35 (manufactured by Daicel Corporation) is prepared as cellulose acetate (CA8).

LT-55 (manufactured by Daicel Corporation) is prepared as cellulose acetate (CA9).

### Synthesis of Cellulose Propionate (CP1)

Cellulose propionate (CP1) is obtained using the same synthesis method of the cellulose acetate (CA1), except that: not 24 kg of acetic anhydride but 40 kg of propionic anhydride and 10 kg of acetic anhydride are added after the pre-treatment and activation; and after the obtained cellulose tripropionate is added dropwise to 200 L of distilled water, the mixture is stirred at room temperature for 1 hour, is filtered, and the resultant residue is dried at 60° C. for 72 hours.

Regarding each of the obtained cellulose acetates (CA1) to (CA9) and the cellulose propionate (CP1), the polymerization degree and the substitution degree thereof are measured using an existing method. The results are shown in Table 2.

TABLE 2

| Type of | Polymerization | Substitution | |
|---|---|---|---|
| Cellulose Ester | Degree | Degree | Substituent |
| CA1 | 520 | 2.25 | Acetyl |
| CA2 | 220 | 2.38 | Acetyl |
| CA2-2 | 240 | 2.66 | Acetyl |
| CA2-3 | 180 | 2.05 | Acetyl |
| CA3 | 120 | 2.42 | Acetyl |
| CA4 | 90 | 2.48 | Acetyl |
| CA5 | 480 | 2.41 | Acetyl |
| CA6 | 600 | 2.41 | Acetyl |
| CA7 | 300 | 2.28 | Acetyl |
| CA8 | 470 | 2.95 | Acetyl |
| CA9 | 600 | 2.95 | Acetyl |
| CP1 | 450 | 2.40 | Propionyl |

### Examples 1 to 21 and Comparative Examples 1 to 10 Kneading

According to a mixing composition ratio shown in Tables 3 and 4, components are kneaded with each other using a twin-screw extruder (TEX41SS, manufactured by Toshiba Machine Co., Ltd.) at a cylinder temperature shown in Tables 5 and 6. In this way, resin compositions according to Examples 1 to 21 and Comparative Examples 1 to 10 are obtained.

### Injection Molding

The obtained resin compositions are molded using an injection molding machine (NEX140 III, manufactured by Nissei Plastic Industrial Co., Ltd.) at cylinder temperatures shown in Tables 5 and 6 to obtain ISO multi-purpose dumbbell specimens (measurement part dimension: width 10 mm/thickness 4 mm) and D2 specimens (length×width: 60 mm×60 mm, thickness: 2 mm). Due to insufficient plasticization, it is difficult to mold the resin compositions according to Comparative Examples 2, 3, and 5 to 8.

### Evaluation

### Transparency

Regarding each of the obtained D2 specimens, the total light transmittance is measured using a haze meter (NDH 7000, manufactured by Nippon Denshoku Industries Co., Ltd.) according to a method defined in JIS K 7361. The results are shown in Tables 5 and 6.

### Bending Elastic Modulus

Regarding each of the obtained ISO multi-purpose dumbbell specimens, the bending elastic modulus is measured using a universal tester (AUTOGRAPH AG-Xplus, manufactured by Shimadzu Corporation) according to a method defined in ISO-178. The results are shown in Tables 5 and 6.

### Molding Stability

Regarding each of the obtained D2 specimens and the obtained ISO multi-purpose dumbbell specimens, molding stability is evaluated based on the following criteria. The results are shown in Tables 5 and 6.

### Evaluation Criteria

G1: Continuous molding may be performed, and no defects such as cracking occur in both the D2 specimen and the ISO multi-purpose dumbbell specimen

G2: Continuous molding may be performed, but cracking occurs in at least either the D2 specimen or the ISO multi-purpose dumbbell specimen

G3: Molding is difficult to perform due to insufficient plasticization.

TABLE 3

| | Composition | | | | | | | | | | | |
|---|---|---|---|---|---|---|---|---|---|---|---|---|
| | Cellulose Nanofibers | | | | | | | | Cellulose Ester Resin | | | |
| | F1 | F2 | F3 | F4 | F5 | F6 | F7 | F8 | CA1 | CA2 | CA2-2 | CA2-3 |
| Example 1 | | | | | | 5 | | | | 100 | | |
| Example 2 | | | | | | 0.1 | | | | 99.9 | | |
| Example 3 | | | | | | 25 | | | | 75 | | |
| Example 4 | | | | | | 2 | | | | 100 | | |
| Example 5 | | | | | | 2 | | | | | | |
| Example 6 | | | | | | 2 | | | | | | |
| Example 7 | | | | | | 2 | | | | | | |
| Example 8 | | | | | | 2 | | | | 100 | | |
| Example 9 | | | | | | 2 | | | | | | |
| Example 10 | | | | | | 2 | | | | | | |
| Example 11 | | | | | | 2 | | | | | | |
| Example 12 | | 2 | | | | | | | | 100 | | |
| Example 13 | | | 2 | | | | | | | 100 | | |
| Example 14 | 2 | | | | | | | | | 100 | | |
| Example 15 | | | | 2 | | | | | | 100 | | |
| Example 16 | | | | | | | 2 | | | 100 | | |
| Example 17 | | | | | | 0.08 | | | | 99.92 | | |
| Example 18 | | | | | | 27 | | | | 73 | | |
| Example 19 | | | | | 2 | | | | | 100 | | |
| Example 20 | | | | | | | | 2 | | 100 | | |
| Example 21 | | | | | 2 | | | | | | | |

| | Composition | | | | | | | | |
|---|---|---|---|---|---|---|---|---|---|
| | | | | | | | | | Adipic Acid |
| | | | | | | | | | Ester- |
| | Cellulose Ester Resin | | | | | | | | Containing |
| Example 1 | CA3 | CA4 | CA5 | CA6 | CA7 | CA8 | CA9 | CP1 | Compound |
| Example 2 | | | | | | | | | |
| Example 3 | | | | | | | | | |
| Example 4 | | | | | | | | | |
| Example 5 | 100 | | | | | | | | |
| Example 6 | | | 100 | | | | | | |
| Example 7 | | | | | 100 | | | | |
| Example 8 | | | | | | | | | 5 |
| Example 9 | 100 | | | | | | | | 3 |
| Example 10 | | | 100 | | | | | | 15 |
| Example 11 | | | | | 100 | | | | 6 |
| Example 12 | | | | | | | | | 5 |
| Example 13 | | | | | | | | | 5 |
| Example 14 | | | | | | | | | 5 |
| Example 15 | | | | | | | | | 5 |
| Example 16 | | | | | | | | | 5 |
| Example 17 | | | | | | | | | |
| Example 18 | | | | | | | | | |
| Example 19 | | | | | | | | | |
| Example 20 | | | | | | | | | |
| Example 21 | | | | | | | | | |

TABLE 4

| | Composition | | | | | | | | | | | | |
|---|---|---|---|---|---|---|---|---|---|---|---|---|---|
| | Cellulose Nanofibers | | | | | | | | Cellulose Ester Resin | | | | |
| | F1 | F2 | F3 | F4 | F5 | F6 | F7 | F8 | CA1 | CA2 | CA2-2 | CA2-3 | CA3 |
| Comparative | | | | | | 2 | | | 100 | | | | |
| Example 1 | | | | | | | | | | | | | |
| Comparative | | | | | | 2 | | | | | 100 | | |
| Example 2 | | | | | | | | | | | | | |
| Comparative | | | | | | 2 | | | | | | 100 | |
| Example 3 | | | | | | | | | | | | | |
| Comparative | | | | | | 2 | | | | | | | |
| Example 4 | | | | | | | | | | | | | |
| Comparative | | | | | | 2 | | | | | | | |
| Example 5 | | | | | | | | | | | | | |
| Comparative | | | | | | 1 | | | | | | | |
| Example 6 | | | | | | | | | | | | | |
| Comparative | | | | | | 10 | | | | | | | |
| Example 7 | | | | | | | | | | | | | |
| Comparative | | | | | | 90 | | | | | | | |
| Example 8 | | | | | | | | | | | | | |
| Comparative | | | | | | 1 | | | | | | | |
| Example 9 | | | | | | | | | | | | | |
| Comparative | | | | | | 2 | | | | | | | |
| Example 10 | | | | | | | | | | | | | |

| | Composition | | | | | | | |
|---|---|---|---|---|---|---|---|---|
| | | | | | | | | Adipic Acid Ester- |
| | Cellulose Ester Resin | | | | | | | Containing |
| | CA4 | CA5 | CA6 | CA7 | CA8 | CA9 | CP1 | Compound |
| Comparative | | | | | | | | 15 |
| Example 1 | | | | | | | | |
| Comparative | | | | | | | | 10 |
| Example 2 | | | | | | | | |
| Comparative | | | | | | | | 10 |
| Example 3 | | | | | | | | |
| Comparative | | | 100 | | | | | 10 |
| Example 4 | | | | | | | | |
| Comparative | | | | | 100 | | | |
| Example 5 | | | | | | | | |
| Comparative | | | | | | 100 | | |
| Example 6 | | | | | | | | |
| Comparative | | | | | | 100 | | |
| Example 7 | | | | | | | | |
| Comparative | | | | | | 100 | | |
| Example 8 | | | | | | | | |
| Comparative | | | | | | 100 | | 15 |
| Example 9 | | | | | | | | |
| Comparative | 100 | | | | | | | 5 |
| Example 10 | | | | | | | | |

TABLE 5

| | Molding Conditions | | | | |
|---|---|---|---|---|---|
| | Kneading | Injection Molding | Evaluation | | |
| | Cylinder | Cylinder | Total Light | Bending Elastic | Molding |
| | Temperature (° C.) | Temperature (° C.) | Transmittance (%) | Modulus (MPa) | Stability |
| Example 1 | 190 | 190 | 90 | 4300 | G1 |
| Example 2 | 190 | 190 | 88 | 3900 | G1 |
| Example 3 | 190 | 190 | 80 | 12500 | G1 |
| Example 4 | 190 | 190 | 94 | 6800 | G1 |
| Example 5 | 190 | 190 | 88 | 4600 | G1 |
| Example 6 | 220 | 220 | 88 | 4900 | G1 |
| Example 7 | 210 | 210 | 94 | 6500 | G1 |
| Example 8 | 180 | 180 | 94 | 6600 | G1 |
| Example 9 | 180 | 180 | 90 | 4600 | G1 |
| Example 10 | 180 | 180 | 89 | 4700 | G1 |
| Example 11 | 180 | 180 | 94 | 6500 | G1 |
| Example 12 | 180 | 180 | 91 | 4900 | G1 |
| Example 13 | 180 | 180 | 90 | 5000 | G1 |
| Example 14 | 190 | 190 | 86 | 4300 | G1 |
| Example 15 | 190 | 190 | 85 | 4200 | G1 |
| Example 16 | 190 | 190 | 85 | 4300 | G1 |
| Example 17 | 260 | 260 | 81 | 3800 | G1 |
| Example 18 | 260 | 260 | 80 | 3800 | G1 |
| Example 19 | 240 | 240 | 82 | 4100 | G1 |
| Example 20 | 190 | 190 | 83 | 3900 | G1 |
| Example 21 | 170 | 170 | 90 | 3800 | G1 |

TABLE 6

| | Molding Conditions | | | | |
|---|---|---|---|---|---|
| | Kneading | Injection Molding | Evaluation | | |
| | Cylinder | Cylinder | Total Light | Bending Elastic | Molding |
| | Temperature (° C.) | Temperature (° C.) | Transmittance (%) | Modulus (MPa) | Stability |
| Comparative Example 1 | 240 | 220 | 75 | 3400 | G2 |
| Comparative Example 2 | 250 | Non-Moldable | — | — | G3 |
| Comparative Example 3 | 250 | Non-Moldable | — | — | G3 |
| Comparative Example 4 | 240 | 180 | 72 | 3500 | G2 |
| Comparative Example 5 | 300 | Non-Moldable | — | — | G3 |
| Comparative Example 6 | 300 | Non-Moldable | — | — | G3 |
| Comparative Example 7 | 300 | Non-Moldable | — | — | G3 |
| Comparative Example 8 | 300 | Non-Moldable | — | — | G3 |
| Comparative Example 9 | 280 | 300 | 66 | 3000 | G2 |
| Comparative Example 10 | 240 | 240 | 78 | 3300 | G2 |

### Description of Tables 3 and 4

Adipic acid ester-containing mixture: “Daifatty-101” manufactured by Daihachi Chemical Industry Co., Ltd.

It is found from the above results that, in Examples, the total light transmittance and the bending elastic modulus are higher than those of Comparative Examples. Accordingly, it is found that, by molding each of the resin compositions according to Examples, a resin molded article having high transparency and high bending elastic modulus may be obtained.

In particular, it is found that, in Examples 1 to 16 and 19 to 21 in which the weight ratio of the cellulose ester resin to the total amount of the resin composition is 75% to 99.9%, a resin molded article having higher transparency and higher bending elastic modulus may be obtained, as compared to Example 18 in which the weight ratio is lower than 75% or Example 17 in which the weight ratio is higher than 99.9%.

In addition, it is found that, in Examples 8, 12, and 13 in which the cellulose nanofibers have an average fiber diameter of 10 nm to 100 nm and an aspect ratio of 100 to 500, a resin molded article having higher transparency and higher bending elastic modulus may be obtained, as compared to in Examples 14, 15, and 16 in which the cellulose nanofibers have an average fiber diameter of less than 10 nm or more than 100 nm and an aspect ratio of lower than 100 or higher than 500.

In addition, it is found that, in Examples 4 and 7 in which the polymerization degree of the cellulose ester resin is 200 to 350, a resin molded article having higher transparency and higher bending elastic modulus may be obtained, as compared to Example 5 in which the polymerization degree is lower than 200 or Example 6 in which the polymerization degree is higher than 350.

In addition, it is found that, in Example 8 in which the resin composition contains the adipic acid ester-containing compound, a resin molded article having higher transparency and higher bending elastic modulus may be obtained at a low molding temperature, as compared to Example 4 in which the resin composition does not contain an adipic acid ester-containing compound. In addition, it is found that, in Examples 9, 10, and 11 in which the resin composition contains the adipic acid ester-containing compound, a resin molded article having higher transparency may be obtained at a low molding temperature, as compared to Examples 5, 6, and 7 in which the resin composition does not contain an adipic acid ester-containing compound.

Further, it is found that, in Examples, molding stability is more satisfactory and molding may be performed at a low temperature, as compared to Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A resin composition comprising:
cellulose nanofibers (A), and
a cellulose ester resin (B) having a polymerization degree of 100 to 500 and a substitution degree of 2.1 to 2.6,
wherein a weight ratio of the cellulose ester resin with respect to a total amount of the resin composition is 75% to 99.9%.

2. (canceled)

3. The resin composition according to claim 1, wherein the polymerization degree is from 200 to 350.

4. The resin composition according to claim 1, wherein the cellulose nanofibers have an average fiber diameter of 10 nm to 100 nm.

5. The resin composition according to claim 1, wherein the cellulose nanofibers have an average fiber diameter of 10 nm to 100 nm and an aspect ratio of 100 to 500.

6. The resin composition according to claim 1, wherein a weight ratio (cellulose nanofibers/cellulose ester resin) of the cellulose nanofibers to the cellulose ester resin is from 0.0008 to 0.40.

7. The resin composition according to claim 1, wherein the cellulose nanofibers are not surface-treated.

8. The resin composition according to claim 1, further comprising:
an adipic acid ester-containing compound.

9. A resin molded article comprising:
the resin composition according to claim 1.

10. A method comprising:
kneading cellulose nanofibers (A) and a cellulose ester resin (B) having a polymerization degree of 100 to 500 and a substitution degree of 2.1 to 2.6 with each other by means of a kneading machine having a cylinder temperature of 180° C. to 220° C. to prepare a resin composition,
wherein a weight ratio of the cellulose ester resin with respect to a total amount of the resin composition is 75% to 99.9%.

11. The resin composition according to claim 1, wherein the cellulose ester resin has a polymerization degree of 120 to 480 and a substitution degree of 2.28 to 2.42.

12. The method according to claim 10, wherein the cellulose ester resin has a polymerization degree of 120 to 480 and a substitution degree of 2.28 to 2.42.

13. A resin composition comprising:
cellulose nanofibers (A), and
a cellulose ester resin (B) having a polymerization degree of 120 to 480 and a substitution degree of 2.28 to 2.42.
